(19) United States
(12) Patent Application Publication
(10) Pub. No.: US 2005/0245639 A1
(43) Pub. Date: Nov. 3, 2005

(54) Drier for air-drying coatings

(76) Inventors: Everardus Arnoldus Oostveen, Bennekom (NL); Fabrizio Micciche, Wageningen (NL); Jacco Van Haveren, Ede (NL); Robert Van Der Linde, Zwolle (NL)

Correspondence Address: MCKENNA LONG & ALDRIDGE LLP, 1900 K STREET, NW, WASHINGTON, DC, 20006, US

(21) Appl. No.: 10/513,226

(22) PCT Filed: May 5, 2003
(86) PCT No.: PCT/NL03/00330

§ 371 Date: Apr. 15, 2005

(30) Foreign Application Priority Data
May 3, 2002 (EP) 02076792.7

(51) Int. Cl. C03C 17/00; C09D 11/00

(52) U.S. Cl. 523/160; 523/161

(57) ABSTRACT

The invention pertains to a drier composition for air-drying alkyd-based coatings, inks, or floor coverings, comprising a combination of the following components: a) a transition metal salt with the formula: (Meⁿ⁺)(X^{k-})ₘ in which Me is the transition metal; X⁻ represents a coordinating ligand; and k− is the valence state of the transition metal and m is the number of ligands X. b) a reducing biomolecule. The reducing biomolecule is in particular ascorbic acid or a derivative thereof, including ascorbyl palmitate.

### FIELD OF THE INVENTION

The present invention relates to a combination of a transition metal salt and a reducing biomolecule as drier for air-drying alkyd-based resins, coatings (such as paint, varnish or wood stain), inks, and linoleum floor coverings. The present invention also relates to the use of a combination of a transition metal salt and a reducing biomolecule as drier for air-drying alkyd-based resins, coatings, inks, and linoleum floor coverings. The present invention is also related to such systems comprising said drier.

### BACKGROUND OF THE INVENTION

Air-drying fatty acids are important constituents of alkyd resins, inks and linoleum floor coverings. In inks and linoleum floor coverings, in addition to alkyd resins, drying oils are applied as such. In alkyd resins, the most widely used air-drying binders in paint formulations, the drying or semi-drying unsaturated fatty acids or oils are generally attached to the polyester backbone of polyols and polycarboxylic acids. Air-drying alkyds dry by evaporation of solvents and the autoxidation and subsequent crosslinking of the unsaturated fatty acid moieties containing at least two double bonds, e.g. linoleic and linolenic acid, according to scheme I (see below).

Linoleic acid and linolenic acid derive their reactivity from the isolated methylene group between the double bonds. Oleic acid, having only one double bond, is relatively unreactive.

The autoxidation is initiated by the abstraction of an allylic hydrogen atom from the fatty acid (LH) as shown in scheme I. The resulting radicals (L•) react with oxygen to form conjugated hydroperoxides (LOOH). Recombination of radicals formed by decomposition of the hydroperoxides results in cross-linking (alkyl, ether or peroxy bridges) and hardening of the alkyd resin.

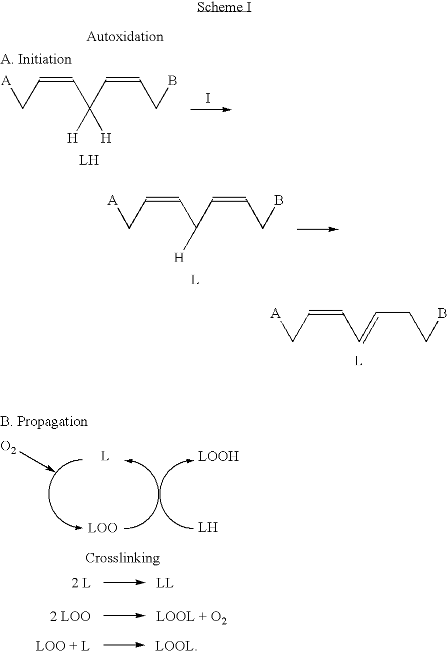

Scheme I: Autoxidation and crosslinking of the unsaturated fatty acid moieties. LH represents an unsaturated fatty acid moiety, LOOH represents a lipid hydroperoxide and I• represents an initiator.

The autoxidation and polymerisation reactions that take place during drying of the paint film will proceed in the absence of a catalyst, but these processes are considerably accelerated by the presence of transition metals, which act as primary driers. The (aut)oxidation is supposed to be triggered by metal oxygen complexes (initiator). The catalytic activity of the transition metal during the decomposition of the hydroperoxides relies on the repeated transition of the metal ion from the lower to the higher oxidation state and vice versa, leading to reduction and oxidation of the hydroperoxides under the formation alkyloxy and peroxy radicals.

Typical driers for alkyd systems, used in e.g. decorative paints or inks are metal salts (soaps) of long chain fatty acids according to formula I:
(Meⁿ⁺)(X⁻)ₙ (I)
in which Me is one of the following elements: V, Mn, Fe, Co, Ce, and Pb, and in which X is a synthetic C₆-C₁₈ aliphatic carboxylate. The carboxylate counterions have only a minor influence on the performance of the metal as a drier, but they usually have a positive impact on the solubility and stability of the primary drier. Systems like these are for example described in U.S. Pat. No. 5,759,252 and DE 4032546.

EP 1057857 describes a drying accelerator for unsaturated fatty acid comprising resins, in which the drying accelerator contains a cobalt soap, a manganese soap and an amino alcohol. This drying accelerator is used as a substitute for lead-based soaps. The manganese soap enhances the drying accelerator with respect to a drying accelerator containing only a cobalt soap and an amino alcohol.

In commercially available drier systems for ambient cure alkyd paints, primary driers are usually combined with auxiliary driers and/or coordination driers. Auxiliary driers comprise metal (Ca, K, Li, and Zn) carboxylates, which do normally not perform a drying function by themselves, but do affect the drying rate by interacting with the transition metal driers. Coordination driers are for example aluminium or zirconium compounds that reinforce the three-dimensional polymer network by forming complexes with hydroxyl groups.

The choice of the metal ion of the primary drier depends upon several parameters like activity at ambient temperatures, possible colouring effects, toxicity, stability in the coating product, price, and the like. It should be taken into account that the activity of the metal ion also depends upon the kind of coordinating groups.

In general, iron displays only slight activity in oxidative drying of coatings or inks systems at ambient temperatures. H. P. Kaufman et al. disclose the use of iron porphyrin complexes [Fette.Seifen.Anstrichmittel, 58 (1956), 520-527] and of iron isoindolenine complexes [Fette.Seifen.Anstrichmittel, 66 (1964) 477-484] for the drying of conjugated drying oils. Iron is much more active at elevated temperatures (>130° C.) and has been used in stoving finishes. Because of its staining power it can usually only be applied in darker coloured finishes. This limits the use of iron as active element.

Because of their good performance at ambient temperature, cobalt-containing driers are the most widely used driers. However, a disadvantage of cobalt is that the catalytic activity of cobalt carboxylates in air-drying coatings and paint compositions diminishes upon standing. The decrease of activity is the most pronounced for waterborne systems (i.e. alkyd emulsions). The loss of drying capacity may be ascribed to hydrolysis of the metal carboxylate and/or adsorption of the drier on the surface of the pigment.

Another possible disadvantage of cobalt is its suspect toxicity (carcinogenicity). Hence, there is an increasing demand in the paint and coating industry for driers for waterborne as well as for solvent-borne systems.

It is an object of the present invention to provide a solution to the above-mentioned problems by the provision of alternative driers, which are non-toxic, or which have to contain less suspect toxic materials, which are stable even in an aqueous environment, which display good air-drying properties at low concentrations and which can dry alkyd-based resins, coatings (such as paint, varnish or wood stain), inks, and linoleum floor coverings at ambient temperatures.

### SUMMARY OF THE INVENTION

In the search to alternative and/or improved driers for alkyd-based resins, coatings, inks, linoleum floor coverings, and the like, the inventors have surprisingly found that combinations of transition metal salts and reducing biomolecules provide a solution to one or more of said problems. This drier of the present invention for alkyd-based resins, coatings (such as paint, varnish or wood stain), inks, and linoleum floor coverings, comprises a combination of the following components: a) a transition metal salt and b) a reducing biomolecule. The transition metal salt in the drier is described according to:
(Meⁿ⁺)(X^{k-})ₘ
in which Me belongs to the group of metals: V, Mn, Fe, Co, Ni, Cu and Ce; X represent ligands like nitrates, sulfates, phosphates, oxalates, salicylates, other carboxylates, naphtenates, EDTA, DTPA and NTA, amino acids and the like; n+ is the valence state of the metal, k− the valence state of the ligand (X), and m is the number of ligands. The reducing biomolecule in the drier according to the present invention, belongs to the group of agents, which can undergo a transition metal catalysed oxidation.

The invention also relates to air-drying alkyd-based resins, coatings, inks, and linoleum floor coverings comprising a drier according to the present invention.

The drier for alkyd-based air-drying resins, coatings, inks and floor coverings according to the present invention can be used in such a way that one or more of the components of the drier are present in the coating, resin, ink or floor covering material before use and/or in which one or more of the components of the drier are added individually or added together to the coating, resin, ink or floor covering material before use.

The invention is also directed to the use of a combination of a transition metal and a reducing biomolecule according (drier of the invention) for drying air-drying alkyd-based coatings, resins, inks, or floor coverings.

### DESCRIPTION OF THE INVENTION

The present invention relates to a drier for alkyd-based resins, coatings, inks, and linoleum floor coverings, comprising a combination of the following components: a) a transition metal salt and b) a reducing biomolecule. The drier accelerates drying (network formation) and can improve properties like adhesion, gloss or hardness of a coating.

The alkyd-based air-drying coatings to which the drier of the present invention can be added, comprise coatings, such as paint, varnish or wood stain, and also includes inks and linoleum floor coverings and the like. The coatings, inks, and linoleum floor coverings may also include compositions wherein besides the alkyd based binder also other binders are present, e.g. compositions comprising 1) an alkyd-based binder and 2) a polyacrylate and/or a polyurethane binder. Conventional air-drying alkyds can be obtained by a polycondensation reaction of one or more polyhydric alcohols, one or more polycarboxylic acids or the corresponding anhydrides, and long chain unsaturated fatty acids or oils.

Due to its presence in naturally occurring oils, glycerol is a widely encountered polyol. Other examples of suitable polyhydric alcohols include: pentaerythritol, dipenta-erythritol, ethylene glycol, diethylene glycol, propylene glycol, neopentyl glycol, trimethylol propane, trimethylol ethane, di-trimethylol propane and 1,6 hexane diol. Polycarboxylic acids and the corresponding anhydrides, used to synthesise alkyds, comprise aromatic, aliphatic and cycloaliphatic components, which are generally derived from petrochemical feedstocks. Typical examples of such polyacids include: phthalic acid and its regio-isomeric analogues, trimellitic acid, pyromellitic acid, pimelic acid, adipic acid, azelaic acid, sebacic acid, maleic acid, fumaric acid and tetra-hydrophthalic acid.

Suitable drying fatty acids, semi-drying fatty acids or mixture thereof, useful herein, are ethylenically unsaturated conjugated or non-conjugated C₁₂-C₂₄ carboxylic acids, such as oleic, ricinoleic, linoleic, linolenic, licanic acid and eleostearic acids or mixture thereof, typically used in the form of mixtures of fatty acids derived from natural or synthetic oils. By semi-drying and drying fatty acids is meant fatty acids that have the same fatty acid composition as the the oils they are derived from. The classsification of the oils is based on the iodine number; for drying oil the iodine number is >140; for semi-drying oil the iodine number is ranging between 125 and 140, and for non-drying oil the iodine number is <125 (“Surface Coatings”, by Swaraj Paul, John Wiley and Sons; p. 89). Suitable organic solvents to dilute the air-drying alkyds of the invention include aliphatic, cycloaliphatic and aromatic hydrocarbons, alcohol ethers, alcohol esters and N-methylpyrrolidone. However it may also be an aqueous carrier containing the alkyd resin in the form of an emulsion and a suitable emulsifier as is well known in the art.

Transition metals useful herein are present as transition metal salts and/or as transition metal complexes. The transition metal salts and/or as transition metal complexes used herein are either called primary driers (e.g. when they are present in alkyd-based air-drying coatings etc) or catalysts. The term metal herein, comprises metal but also the metal ion (in its different valence states). The term ‘charged ligands’ comprises inorganic or organic ions (anions), complexes of ions or organic molecules that have an electric charge. The term ‘neutral ligand’ or ‘uncharged ligand’ usually comprises organic molecules which are uncharged.

Typical transition metals in the drier are V, Mn, Fe, Co, Ni, Cu and/or Ce. This implies that n+ varies from 0 to 7+, but especially those metals are preferred that have valencies between 2+ and 7+ like Fe, Ce and Mn. The catalytic activity of the transition metal during the decomposition of the peroxides relies on the repeated transition of the metal ion from the lower to the higher oxidation state and vice versa, leading to reduction and/or oxidation of the peroxides under the formation alkyloxy and peroxy radicals.

The charge (k−) on the ligands (X) depends on the chosen charged ligands (or combinations of ligands), implying that also the number of ligands (m) depends on the chosen combination of transition metal and charged ligand(s). Usually, the charge of the ligand (X) will be found between −1 and −4. Charged ligands present in the first or further coordination spheres of the transition metal can coordinate to one or more other transition metals (or in case other charged ions or molecules are present, to those species); in this way the ligands and their charges are shared. When e.g. adding the drier to the resin or coating, and/or during reaction, the charged ligands may be (partially) exchanged by other charged ligands which are present in the resin or coating.

The person skilled in the art can choose a drier of the present invention comprising a combination of transition metal salts. This means e.g. one kind of transition metal, but different coordinating ions or ligands; different transition metal ions and one kind of coordinating ions or ligands; and combinations of these. This implies that ‘n+’, ‘m’ and the symbol ‘k−’ in the formulas are the mean values of the valencies of the transition metal ion, of the number of surrounding ligands (X), and of the valencies of the surrounding ligands, respectively. For example (when sharing of charged ligands is not taken into account), a divalent transition metal ion can be surrounded by two (different) monovalent ligands, but a divalent transition metal ion can also be coordinated to one divalent ligand.

It should be noted that the drier of the present invention comprises a transition metal salt, but that this salt, when applied, will most likely partly or completely be dissolved in the alkyd resin, emulsion etc. The transition metal ion in the alkyd resin, emulsion can also be surrounded and/or coordinated by solvent molecules or other molecules or ions that are present in the alkyd resin, emulsion (e.g. surfactants).

The catalytic activity of the transition metal ion depends upon the ion itself and on the type of charged ligands, such as nitrates, sulfates, phosphates, oxalates, carboxylates, naphthenates, salicylates, EDTA, DTPA, NTA, amino acids and the like.

The drier of the present invention for alkyd-based resins, coatings (such as paint, varnish or wood stain), inks, or linoleum floor coverings comprises a combination of the following components:

a) a transition metal salt with the formula:
(Meⁿ⁺)(X^{k-})ₘ (I)
in which Me belongs to the group of metals of transition metals like V, Mn, Fe, Co, Ni, Cu and Ce; X^{k-} represents ligands like nitrates, sulfates, phosphates, oxalates, salicylates, other carboxylates, naphtenates, EDTA, DTPA and NTA, amino acids and the like; and n+ is the valence state of the metal, k− the valence state of the charged ligand (X), and m is the number of ligands,

b) a reducing biomolecule.

Preferred transition metals are non-toxic metals like Fe and Mn. However, in the present invention also metals which might be less favourable because of their suspect toxicity, like Co or Cu, can be used. This is due to the fact that the driers of the present invention have a better drying capacity than conventional driers based on Co, and thus less drier is needed. Preferred X ions belong to the group of sulfates and carboxylates (especially C6-C18 aliphatic carboxylates) and/or those that facilitate the electron transfer to the oxidized metal, such as salicylates, EDTA, DTPA and NTA, amino acids and the like. An advantage of the drier of the present invention is that it can be applied without the addition of peroxide initiatiors.

In a specific embodiment, the transition metal salt is also surrounded by complexing agents or neutral ligands like 2,2-bipyridyl, imidazoles, pyrazoles, aliphatic and aromatic amines, 1,10-phenanthrolin, 1,4,7-trimethyl-1,4,7-tri-azacyclononane, and the like. In such a case, a transition metal salt (or complexed transition metal salt) of the drier of the present invention for air-drying alkyd-based coatings, resins, inks and floor coverings is described according to:
(Meⁿ⁺)(X^{k-})ₘ(L)ₒ (II)
in which Me, X, and n+, k− and m have their previous meaning, L represents a neutral ligand, especially an organic ligand containing two or more nitrogen atoms, such as 2,2-bipyridyl, imidazoles, pyrazoles, aliphatic and aromatic amines, 1,10-phenanthrolin, 1,4,7-trimethyl-1,4,7-triaza-cyclo-nonane and other ligand systems that facilitate the electron transfer to the oxidized metal; and o refers to the number of uncharged ligands (L), which is 1 or higher. Adding organic ligands such as 2,2-bipyridyl, imidazoles, pyrazoles, aliphatic and aromatic amines, 1,10-phenanthrolin, 1,4,7-trimethyl-1,4,7-tri-azacyclononane and the like can sometimes be helpful to influence the reduction potential of the transition metal ion and by that enhance the drying properties of the drier system.

Formula (II) should be understood in this way, that the partly or completely dissolved transition metal salt ion in the alkyd resin or emulsion is coordinated by one or more charged ligands (X) and by one or more neutral L ligands. Hence, the term transition metal salt herein also means a transition metal salt that is partly or completely dissolved in the alkyd resin or emulsion and can be described according to formula II.

The reducing biomolecule is the other important component of the combination in the drier of the present invention for air-drying alkyd-based coatings, resins, inks, or floor coverings. The term biomolecule herein means a compound that is available in living systems, and derivatives of such compounds. The reducing biomolecule belongs to the group of biomolecules, which can undergo a transition metal catalysed autoxidation. Preferred reducing biomolecules in the present invention belong to the groups of mono-, oligo- and polyhydroxy-substituted (hetero)-aromatic compounds, like tocopherol, hydrochinon, catechol, pyrogallol, (hydroxy)-dopamine, epinephrine, homogenesic acid, dialuric acid, their derivatives and the like; the group of ascorbic acid, or salts, esters and derivatives thereof, such as ascorbyl palmitate, and the like; the group of electron-rich hetero-aromatic compounds, like (substituted) flavins, imidazoles, triazoles and the like; and the group of thiols like cysteine, cysteamine, glutathione, dithiothreitol, their derivatives and the like. Preferred reducing biomolecules are ascorbic acid, ascorbyl palmitate, and the like. The person skilled in the art can choose to apply a drier of the present invention comprising transition metal salts according to formula I and/or II and a combination of reducing biomolecules.

Another preferred embodiment comprises a drier in which the coordinating ions and/or charged ligands (X) are the reducing biomolecules themselves. An example of such a drier is manganese ascorbate, where the manganese ion is the transition metal catalysing the drying, and the ascorbate ion enhances as reducing system this catalytic action and improves the drying capacity.

The drier of the present invention can, if desired or if necessary, also comprise other additives like auxiliary driers and/or coordination driers, especially for alkyd-based resins or coatings. Hence, another embodiment of the invention is a drier for air-drying alkyd-based resins, coatings, inks, or floor coverings, comprising a combination of the following components: a) a transition metal salt, b) a reducing biomolecule, and c) one or more of the group of auxiliary driers and coordination driers. Auxiliary driers comprise metal (Ca, K, Li, and Zn) carboxylates, which do normally not perform a drying function but do affect the drying rate by interacting with the transition metal driers. Coordination driers are for example aluminium or zirconium compounds that reinforce the three-dimensional polymer network by forming complexes with hydroxyl groups.

The drier of the present invention can be added to the alkyd-based resin or coating (such as paint, varnish or wood stain, and the like) before use, but can also be present in the commercially available alkyd-based coating or resin. The same applies to the inks and floor coverings, and the like, in which the drier of the present invention can be used. Thus, the present invention also relates to air-drying alkyd-based resins, coatings (such as paint, varnish or wood stain), inks, or linoleum floor coverings, and the like, comprising the drier described above, and also pertains to the use of the drier for this purpose.

The drier of the present invention can be used in different ways. Commercially available air-drying alkyd-based coatings, resins, inks, floor coverings, often already comprise transition metal salts as primary drier. To improve the drying capacity of such alkyd-based resins or coatings, one can confine oneself to add the reducing biomolecule, but one can also choose to add both a reducing biomolecule and a transition metal salt. Other alkyd-based resins or coatings may be without transition metal salts as primary drier and thus both components (a and b) of the drier combination of the present invention have to be added. Of course one can choose to add also auxiliary driers and/or coordination driers, especially for alkyd-based resins or coatings. Hence, another aspect of the invention is the use of a drier for air-drying alkyd-based coatings, resins, inks, or floor coverings, in which one or more of the components of the drier are already present in the coating, ink, floor covering or resin material before use and/or in which one or more of the components of the drier is added individually or added together to the air-drying alkyd-based coatings, resins, inks, or floor coverings, before use.

The drier of the invention thus allows the user different methods to apply the drier. It can either be applied by: addition of a drier to the resin; or by addition of a drier in which one or more of the components of the drier are already present in the alkyd-based resin, coating, ink, or linoleum floor covering and in which one or more of the components of the drier is added individually or added together to the alkyd-based resin, coating, ink, and linoleum floor covering material before use.

In a further aspect of the invention, the invention is also directed to an air-drying alkyd-based coating, resin, ink, or floor covering comprising a drier according to the invention, e.g. containing 0.01-0.5 wt. % (metal based on the amount of binder) of a transition metal salt, and a reducing biomolecule, with a molar ratio of transition metal to reducing biomolecule between 10 and 0.05. The air-drying alkyd-based coating, resin, ink, or floor covering may further comprise a polyacrylate and/or a polyurethane binder.

The invention is also directed to the use of a combination of a transition metal and a reducing biomolecule according to the invention, in compositions comprising a binder combination of 1) an alkyd-based binder and 2) a polyacrylate and/or a polyurethane binder.

To obtain a drier for air-drying alkyd-based resins, coatings, inks, or floor coverings with good drying properties at ambient temperatures, the molar ratio of a) transition metal to b) reducing biomolecule should be optimal. This optimal molar ratio will depend on the kind of transition metal salt and/or complex (i.e. upon the metal itself and on the type of coordinating ions or ligands) and the kind of reducing biomolecule.

The skilled person in the art can find by a few tests the molar ratio which is useful. Generally, the molar ratio of the transition metal to reducing biomolecule is between approximately 10 and 0.05. Too small ratio's (too much reducing biomolecule) leads to a change from a pro-oxidant effect to an anti-oxidant effect, causing a scavenging of the radicals. This stops the necessary propagation reaction during the drying process. Too high ratio's (not enough reducing biomolecule) means, e.g. in the case of iron-based drier, that not enough Fe(III) is reduced to Fe(II), and this is comparable to the state of the art coatings, inks and floor coverings or resins without a reducing biomolecule. A preferred molar ratio of transition metal to reducing biomolecule is between 5 and 0.1. In aqueous emulsions, it has surprisingly been found that the catalytic action of the transition metal is not dependent on the pH over a broad pH-range (pH 3.5-7.5).

Next to the molar ratio of the transition metal to the reducing biomolecules, also the amount of drier added is important. This amount will depend on the kind of drier (i.e.: kind of combination of transition metal salts and reducing biomolecules), the kind of alkyd-based resin and the method used. The amount will of course differ when transition metal salts (like e.g. Co—C₆-C₁₈ aliphatic carboxylate) are already present in the resin or if they are absent. Generally, the amount of transition metal salts should be between approximately 0.01 and 0.5 wt. % (metal based on the amount of binder, i.e. alkyd resin). The amount of reducing biomolecule can be derived from the preferred molar ratio mentioned above. If appropriate, especially for alkyd-based resins or coatings, also one or more of the group of auxiliary driers, coordination driers and drying alkyds can be added.

The addition of the drier itself is done with conventional techniques, known to the person skilled in the art. The drier is either added during the production of the alkyd-based resins, coatings, inks, and linoleum floor coverings, or is added under stirring to them before use. As described above, combinations of these procedures are also possible. Stirring can be done by known means. It is necessary to get a good distribution of the drier through the coating or resin. Together with the drier, also organic substances chosen from the group of imidazoles (like e.g. 2-Ethyl-4-methyl-imidazole, N,N-bis-(2-ethyl-4-methylimidazol-5-ylmethyl)aminopropane (BIAP)), pyrazoles, aliphatic and aromatic amines, 2,2-bipyridyl, 1,10-phenanthrolin, 1,4,7-trimethyl-1,4,7-tri-azacyclononane, and the like, can be added.

### EXAMPLES

Starting Materials:

In the examples, the following chemicals and materials are used:
Iron sulfate: Fe (II)SO₄.7H₂O (p.a), from Acros
Ascorbic acid (99+%), also indicated with AsA, from Acros
Nuodex WEB Co 6: cobalt carboxylate, a primary drier based on (6 w/w) % Co from Sasol Servo B V, Delden, Netherlands
Nuodex Fe 10: iron carboxylate, a primary drier based on 10% (w/w) Fe from Sasol Servo B V, Delden, Netherlands
DSM WB paint based on URADIL AZ 554 Z-50 (alkyd emulsion; solid material content is approximately 50% wt. %; oil length: appr. 40%; type of fatty acid: special processed soybean). The paint also comprises TiO₂ and a number of additives.
Alkyd emulsion URADIL AZ 516 Z-60 (solid material content is approximately 50% wt. %; oil length: appr. 63%; type of fatty acid: tallow oil). The paint also comprises TiO₂ and a number of additives.
Uralac AD43 W-70 (70 wt. % in white spirit; oil length: appr. 63%; type of oil: soya-bean)
Uralac AD142 W-50 (50 wt. % in white spirit; oil length: appr. 53%; type of oil: linseed)
Setal 16 LV WS-70: a white solvent-borne paint (70 wt. % in white spirit; type of oil: linseed)
Methyl linoleate (99%), from Aldrich
Sodium dodecyl sulfate (99%), from Acros
Ascorbyl palmitate, from Sigma
Ascorbyl octanoate, ascorbyl laurate, ascorbyl stearate and ascorbyl linoleate: P. L. Nostro, Langmuir 2000 (16), 1744
2-Butoxyethanol (99%), from Merck
Exkin 2: methyl ethyl ketoxime, from Sasol Servo B V, Delden, Netherlands
2-Ethyl-4-methylimidazole: Acros
N,N-bis-(2-ethyl-4-methylimidazol-5-ylmethyl)aminopropane (BIAP): E. Bouman et al., Inorg. Chim. Acta, 2000, 304, 250
   Test Methods

All experiments and measurements were performed at about 23° C. The drying time was determined by B.K. drying (wet film thickness: 76 μm; ASTM D5895-96) and a Braive recorder (wet film thickness: 76 μm; ASTM D5895-96). After the application of the film on a glass strip (B.K. recorder: 69×2.5 cm; Braive recorder: 30.5×2.5 cm) a vertical blunt needle is positioned in to the freshly applied film by a 5 g load and then dragged through the drying paint in a direction parallel to the length of the coat.

The three stages in the Braive recorder experiment are described as stage a: the paint flows together (levelling), i.e. the paint is wet; stage b: a line is visible, the paint begins to polymerise, this is the basis trace; stage c: this is the so-called “surface dry time”. This condition is reached when the drying reactions have proceeded sufficiently. At this condition the film is not displaced anymore. The drying was further established by hand according to ASTM D1640 (wet film thickness: 60 μm).

For the determination of the “surface dry time” the cotton fiber test method was applied. The through drying state was determined by the use of a “mechanical thumb” device.

The König hardness of the films was assessed by using the pendulum damping test according to DIN53157. A glass panel was coated with a 60 μm wet film, kept under conditions of 23° C. and 50% RH (relative humidity) and the hardness development in time was monitored with a König pendulum. The oscillation time measured to reduce the deflection from initial 6° to 3° is given in seconds.

The whiteness index was determined using a “Color Reader CR-10” of Minolta by comparing the whiteness of the paint film with that of a standard white sheet.

The invention is not limited to the examples and is also not limited to the mentioned biomolecules. Also other (organic) molecules or biomolecules which effectively can reduce transition metal ions can be used in the invention.

### EXAMPLE 1

A standard commercial coating composition, DSM WB paint based on URADIL AZ 554 Z-50, was combined with the siccatives (0.1 wt. % metal based on the amount of URADIL AZ 554 Z-50 binder) according to the series described in Table I. In the experiment 1, only catalyst is added (Co based), in experiments 2-5 catalyst and reducing biomolecule, i.e. the drier according to the present invention, is added, and in experiment 6 no catalyst is added. In the cases in which the drier according to the present invention was added, the added amount was kept constant, but the molar ratio of metal to ascorbic acid was varied.

TABLE I
Drying of a commercial coating composition: DSM WB paint based on
URADIL AZ 554 Z-50

| | | | | | | | | B.K. |
|---|---|---|---|---|---|---|---|---|
| | | | | | | | | recorder |
| | | Molar | | | | By hand | | (10° C.; 25% |
| | | ratio | Braive recorder | | | (23° C.; 50% RH) | | RH) |
| | | metal/ | (23° C.; 50% RH) | | | (hours) | | (hours) |
| | | Ascorbic | (hours) | | | Surface | Through | Total |
| Exp. | Catalyst | acid | Stage a | Stage b | Stage c | dry | dry | dry |
| 1 | WEB Co 6 | — | 0.04 | — | ±5 | 1.00 | ±4.00 | 6.30 |
| 2 | Fe**/AsA* | 1/2 | 0.07 | 0.47 | 3.40 | 0.30 | ±4.00 | 3.15 |
| 3 | Fe**/AsA* | 1/4 | 0.08 | 0.50 | 3.50 | 0.30 | ±4.00 | 3.00 |
| 4 | Fe**/AsA* | 1/5 | 0.07 | 0.52 | 4.25 | 0.30 | ±4.00 | n.d |
| 5 | Fe**/AsA* | 1/6 | 0.10 | 0.42 | >5 | 0.30 | ±4.00 | n.d |
| 6 | No catalyst | — | 0.14 | — | >5 | 1.30 | >8.00 | >12.00 |

*AsA: Ascorbic acid;
**Fe: iron sulfate

TABLE II
König hardness development during drying

König hardness at 23° C.
and 50% RH (seconds)

| Exp. | Catalyst | 8 hrs | 1 day | 3 days | 1 week |
|---|---|---|---|---|---|
| 1 | WEB Co 6 | 24 | 31 | 38 | 45 |
| 2 | Fe/AsA 1/2 | 21 | 24 | 28 | 29 |
| 3 | Fe/AsA 1/4 | 20 | 22 | 27 | 29 |
| 4 | Fe/AsA 1/5 | 17 | 21 | 27 | 26 |
| 5 | Fe/AsA 1/6 | 17 | 20 | 25 | 28 |
| 6 | No catalyst | 10 | 10 | 14 | 17 |

### EXAMPLE 2

A commercial alkyd emulsion, URADIL AZ 516 Z-60, was mixed with the catalyst (combination) consisting of the metal salt (0.07 wt. % metal based on solid binder) and the reducing biomolecule ascorbic acid. The resulting mixture was applied with a 60 μm film applicator on glass plates. The results of the drying tests (B.K. recorder; Königs hardness) are summarised in table III.

TABLE III
Drying tests of a commercial alkyd emulsion: URADIL AZ 516 Z-60

| | | | | König hardness |
|---|---|---|---|---|
| | | Molar ratio | B.K. recorder | at 23° C. |
| | | metal/Ascorbic | (23° C.) | (seconds) |
| Exp. | Catalyst | acid (AsA) | (total dry; hours) | (after 20 h) |
| 1 | WEB Co 6 | — | 5.4 | 9.8 |
| 2 | Fe/AsA | 1/2 | 8.8 | 8.4 |
| 3 | Fe/AsA | 1/4 | 6.0 | 9.8 |
| 4 | Fe/AsA | 1/6 | 9.2 | 8.4 |
| 5 | No catalyst | — | >24 | — |

### EXAMPLE 3

A commercial solvent-borne alkyd resin, Uralac AD43 W-70 (70 wt. % in white spirit), was mixed with the catalyst (combination) consisting of the metal salt (0.07 wt. % metal based on solid binder) and the reducing biomolecule ascorbyl palmitate—added as a 10 wt. % solution in butoxyethanol. The resulting mixture was applied with a 60 μm film applicator on glass plates. The results of the drying tests (B.K. recorder; Königs hardness) are summarised in table III.

TABLE IV
Drying tests of a commercial solvent-borne alkyd resin: Uralac AD43 W-70

| | | Molar ratio Fe/ | B.K. recorder | König hardness at 23° C. | | |
|---|---|---|---|---|---|---|
| | | Ascorbyl | (23° C.) | (seconds) | | |
| Exp. | Catalyst | Palmitate | (total dry; hours) | 20 hrs | 43 hrs | 164 hrs |
| 1 | Nuodex Fe 10 | — | >24 | — | 8.4 | 15.4 |
| 3 | Nuodex Fe 10/ | 1/4 | 8-10 | 9.8 | 15.8 | 24.3* |
| | Ascorbyl | | | | | |
| | Palmitate | | | | | |
| 5 | No catalyst | — | >>24 | — | — | 11.2 |

*Addition of ascorbyl palmitate gave rise to a considerable reduction of the colour of the film.

### EXAMPLE 4

A commercial solvent-borne alkyd resin, Uralac AD142 W-50 (50 wt. % in white spirit), was mixed with the catalyst (combination) consisting of the metal salt (0.07 wt. % metal based on solid binder) and the reducing biomolecule (molar ratio metal salt/reducing biomolecule: 1/0.4)—added as a 10 wt. % solution in butoxyethanol. The resulting mixture was applied with a 60 μm film applicator on glass plates. The results of the drying tests (Braive recorder; König hardness) are summarised in table V.

TABLE V
Drying tests of a commercial solvent-borne alkyd resin: Uralac AD142 W-50

| | Catalyst | | Braive recorder | König hardness at 23° C. | | |
|---|---|---|---|---|---|---|
| | | Reducing | (23° C.) | (seconds) | | |
| Exp. | Metal | biomolecule | (total dry; hours) | 21 hrs | 45 hrs | 164 hrs |
| 1 | Nuodex Fe 10 | Ascorbyl octanoate | 10 | 13 | 55 | 110 |
| 2 | Nuodex Fe 10 | Ascorbyl laurate | 5 | 14 | 63 | 120 |
| 3 | Nuodex Fe 10 | Ascorbyl palmitate | 5 | 14 | 61 | 116 |
| 4 | Nuodex Fe 10 | Ascorbyl linoleate | 8.6 | 13 | 50 | 113 |
| 5 | Nuodex Fe 10 | Ascorbyl stearate | 4.5 | 14 | 68 | 123 |
| 5 | Nuodex Fe 10 | — | >>>24 | — | — | 78 |
| 5 | WEB Co 6/ | — | 11.2 | 35 | 65 | 96 |
| | Exkin 2* | | | | | |

*Exkin 2: 0.3 wt. %

### EXAMPLE 5

A commercial solvent-borne alkyd resin, Uralac AD142 W-50 (50 wt. % in white spirit), was mixed with the catalyst (combination) consisting of the metal salt (0.07 wt. % metal based on solid binder), the reducing biomolecule ascorbyl palmitate (added as a 10 wt. % solution in butoxyethanol) and the ligand. The resulting mixture was applied with a 60 μm film applicator on glass plates. The results of the drying tests (Braive recorder; König hardness) are summarised in table VI.

TABLE VI
Drying tests of a commercial solvent-borne alkyd resin: Uralac AD142 W-50

| | | | Molar | Braive | König |
|---|---|---|---|---|---|
| | | | ratio | recorder | hardness |
| Catalyst | | | metal/ | (23° C.) | at 23° C. |
| | Reducing | | biomolecule/ | (total dry; | (seconds) |
| Metal | biomolecule | Ligand | ligand | hours) | 120 hrs |
| Nuodex Fe 10 | Ascorbyl palmitate | — | 1/1/0 | 8.5 | 90 |
| Nuodex Fe 10 | Ascorbyl palmitate | — | 1/2/0 | 4 | 96 |
| Nuodex Fe 10 | Ascorbyl palmitate | — | 1/3/0 | 3.4 | 75 |
| Nuodex Fe 10 | Ascorbyl palmitate | — | 1/4/0 | 4.6 | 107 |
| Nuodex Fe 10 | Ascorbyl palmitate | 2-ethyl-4-methyl- | 1/1/4 | 8.2 | 95.5 |
| | | imidazole | | | |
| Nuodex Fe 10 | Ascorbyl palmitate | 2-ethyl-4-methyl- | 1/2/4 | 8.9 | 106 |
| | | imidazole | | | |
| Nuodex Fe 10 | Ascorbyl palmitate | 2-ethyl-4-methyl- | 1/3/4 | >21 | 79.5 |
| | | imidazole | | | |
| Nuodex Fe 10 | Ascorbyl palmitate | BIAP | 1/1/2 | 5.1 | 69 |
| Nuodex Fe 10 | Ascorbyl palmitate | BIAP | 1/2/2 | 4.3 | 96 |
| Nuodex Fe 10 | Ascorbyl palmitate | BIAP | 1/3/2 | 6.5 | 87 |
| Nuodex Fe 10 | Ascorbyl palmitate | BIAP | 1/4/2 | 10 | 65 |
| WEB Co 6/ | — | — | 1/0/0 | 14 | 89 |
| Exkin 2* | | | | | |

*Exkin 2: 03 wt. %

### EXAMPLE 6

A commercial high gloss white paint, Setal 16 LV WS-70 (70 wt. % in white spirit), was mixed with the catalyst (combination) consisting of the metal salt (0.07 wt. % metal based on solid binder), the reducing biomolecule ascorbyl palmitate (added as a 10 wt. % solution in butoxyethanol) and the ligand. The resulting mixture was applied with a 60 μm film applicator on glass plates. The results of the drying tests (Braive recorder; König hardness) are summarised in table VII.

TABLE VII
Drying tests of a commercial high gloss white paint, Setal 16 LV WS-70

| | | | | Braive | | |
|---|---|---|---|---|---|---|
| | | | Molar ratio | recorder | König | |
| Catalyst | | | metal/ | (23° C.) | hardness at | |
| | Reducing | | bio-molecule/ | (total dry; | 23° C. (seconds) | Whiteness |
| Metal | bio-molecule | Ligand | ligand | hours) | 120 hrs | Index |
| Nuodex Fe | Ascorbyl | — | 1/1/0 | 8.8 | 76 | 80.2 |
| 10 | palmitate | | | | | |
| Nuodex Fe | Ascorbyl | — | 1/2/0 | 10 | 69 | 80.3 |
| 10 | palmitate | | | | | |
| Nuodex Fe | Ascorbyl | — | 1/3/0 | 7.0 | 74 | 80.1 |
| 10 | palmitate | | | | | |
| Nuodex Fe | Ascorbyl | — | 1/4/0 | 6.6 | 68 | 80.0 |
| 10 | palmitate | | | | | |
| Nuodex Fe | Ascorbyl | 2-ethyl-4- | 1/1/4 | 4.5 | 74 | 80.6 |
| 10 | palmitate | methyl- | | | | |
| | | imidazole | | | | |
| Nuodex Fe | Ascorbyl | 2-ethyl-4- | 1/2/4 | 2.2 | 81 | 80.8 |
| 10 | palmitate | methyl- | | | | |
| | | imidazole | | | | |
| Nuodex Fe | Ascorbyl | 2-ethyl-4- | 1/3/4 | 5.8 | 85 | 81.5 |
| 10 | palmitate | methyl- | | | | |
| | | imidazole | | | | |
| Nuodex Fe | Ascorbyl | 2-ethyl-4- | 1/4/4 | 6.6 | 80 | 81.2 |
| 10 | palmitate | methyl- | | | | |
| | | imidazole | | | | |
| Nuodex Fe | Ascorbyl | BIAP | 1/1/2 | 6.7 | 57 | 81.4 |
| 10 | palmitate | | | | | |
| Nuodex Fe | Ascorbyl | BIAP | 1/2/2 | 7.5 | 63 | 81.1 |
| 10 | palmitate | | | | | |
| Nuodex Fe | Ascorbyl | BIAP | 1/3/2 | 8.5 | 72 | 80.8 |
| 10 | palmitate | | | | | |
| Nuodex Fe | Ascorbyl | BIAP | 1/4/2 | 6.8 | 49 | 81.3 |
| 10 | palmitate | | | | | |
| WEB Co 6/ | — | — | 1/0/0 | 14 | 73 | 82.8 |
| Exkin 2* | | | | | | |

*Exkin 2: 0.3 wt. %

### EXAMPLE 7

An emulsion of methyl linoleate (0.5 wt. %) was prepared using sodium dodecyl sulphate (3.8 wt. %) as emulsifier. To the emulsion thus obtained mixtures according to the present invention, iron sulphate (0.07 wt. % of iron based on methyl linoleate) and ascorbic acid (as reducing biomolecule) were added at room temperature. The amount of iron sulphate was held constant, the molar ratio Fe to ascorbic acid was varied between 1/1 to 1/6. The oxidation of the emulsions in cuvets at 23° C. was monitored by UV-spectroscopy (Perkin Elmer UV/VIS Lambda 16) by reading the increase of the absorbance at 233 nm (at the 233 nm wavelength, the conjugated dienylhydroperoxide can be monitored). The measurements are started after addition of the catalyst and reducing biomolecule combination.

The composition of the emulsion (ascorbic acid not included, since this amount is varying, see above) is:

Methyl linoleate: 0.5% (w/w)

Sodium dodecyl sulphate: 3.8% (w/w)

Iron sulphate: 0.07 wt. % based on methyl linoleate.

The conversions of the methyl linoleate, after four hours of incubation, with different ratio's of iron/ascorbic acid are summarised in table IX.

TABLE VIII
Iron/Ascorbic acid catalysed hydroperoxidation of methyl linoleate

| | | Molar Ratio | Conversion |
|---|---|---|---|
| Exp. | Catalyst | Iron/Ascorbic acid | (%) |
| 1 | Fe/AsA | 1/1 | 2.2 |
| 2 | Fe/AsA | 1/2 | 3.3 |
| 3 | Fe/AsA | 1/4 | 11.0 |
| 4 | Fe/AsA | 1/5 | 11.5 |
| 5 | Fe/AsA | 1/6 | 9.7 |

### EXAMPLE 8

Experiment 7 is repeated, but now with manganese. The catalysts have Mn/AsA ratios of 1/0.25, 1/0.5 and 1/1.

1-14. (canceled)

15. A compound for air-drying alkyd-based coatings, resins, inks, or floor coverings, comprising a combination of the following components:
(a) a transition metal salt with the formula:
(Meⁿ⁺)(X^{k-})ₘ
in which
Me is the transition metal;
X^{k-} represents a coordinating ligand group;
n is the valence state of the transition metal;
k is the valence state of the ligand X, and
m is the number of ligand groups x coordinating to the transition metal; and
(b) a reducing biomolecule:

16. A compound according to claim 15, in which the reducing biomolecule is ascorbic acid, or a salt, ester or derivative thereof.

17. A compound according to claim 15, in which the transition metal is Mn or Fe.

18. A compound according to claim 15, with a molar ratio of transition metal to reducing biomolecule of between 10 and 0.05.

19. A compound according to claim 15, further comprising one or more of an auxiliary drier, a coordination drier or a drying alkyd.

20. A compound according to claim 15, in which the transition metal salt is a complex having formula II:
(Meⁿ⁺)(X^{k-})ₘ(L)ₒ (II)
in which L represents an organic ligand group, o is the number of ligand groups L, and wherein o≧1.

21. A compound according to claim 20 wherein L is selected from the group consisting of an imidazole; a pyrazole; an aliphatic amine; an aromatic amine; 2,2-bipyridyl; 1,10-phenanthrolin; and 1,4,7-trimethyl-1,4,7-tri-azacyclononane

22. An air-drying alkyd-based coating, resin, ink, or floor covering comprising a compound according to claim 15.

23. An air-drying, alkyd-based coating, resin, ink or floor covering comprising a compound according to claim 20.

24. An air-drying, alkyd-based coating, resin, ink or floor covering comprising a compound according to claim 21.

25. An air-drying alkyd-based coating, resin, ink, or floor covering according to claim 22, comprising:
(a) 0.01-0.5 wt % of the transition metal salt, wherein the percent of the metal is calculated based on the amount of binder, and
(b) a reducing biomolecule,
wherein the molar ratio of transition metal to reducing biomolecule is between 10 and 0.05.

26. An air-drying alkyd-based coating, resin, ink, or floor covering according to claim 22 further comprising a polyacrylate binder and/or a polyurethane binder.

27. A method of using a compound according to claim 15, to produce an air-drying alkyd-based coating, resin, ink, or floor covering.

28. A method of using a compound according to claim 20, to produce an air-drying alkyd-based coating, resin, ink, or floor covering.

29. A method of using a compound according to claim 21, to produce an air-drying alkyd-based coating, resin, ink, or floor covering.

30. A method for air-drying an alkyd-based coating, a resin, an ink, or a floor covering material, comprising adding components of the compound of claim 15 to the air-drying alkyd-based coating, resin, ink, or floor covering.

31. The method of claim 30 wherein the coating, resin, ink or floor covering material comprises:
(a) an alkyd-based binder; or
(b) a polyacrylate binder; and/or
(c) a polyurethane binder.

32. The method of claim 30 wherein the transition metal is Fe and/or Mn, and the reducing biomolecule is ascorbic acid, ascorbate or ascorbyl palmitate.

33. A method for air-drying an alkyd-based coating, resin, ink, or floor covering material, comprising adding components of the compound of claim 20 to the air-drying alkyd-based coating, resin, ink, or floor covering.

34. A method according to claim 30, wherein, prior to its use in air-drying, the coating, resin, ink or floor covering material
(i) was treated with the transition metal salt component, and the method further comprises adding the reducing biomolecule component to the coating resin, ink or floor covering material before said use; or
(ii) was treated with the reducing biomolecule, and the method further comprises adding the transition metal salt component to the coating resin, ink or floor covering material before said use.
